(19) United States
(12) Patent Application Publication
(10) Pub. No.: US 2009/0159640 A1
(43) Pub. Date: Jun. 25, 2009

(54) Wave soldering apparatus

(75) Inventor: Weiming Liu, Shen Zhen (CN)

Correspondence Address: DAVIDSON BERQUIST JACKSON & GOWDEY LLP, 4300 WILSON BLVD., 7TH FLOOR, ARLINGTON, VA, 22203, US

(73) Assignee: Universal Scientific Industrial Co., Ltd., Tsao-Tun Chen (TW)

(21) Appl. No.: 12/153,667

(22) Filed: May 22, 2008

(30) Foreign Application Priority Data
Dec. 21, 2007 (TW) 096221840

(51) Int. Cl. B23K 1/08

(52) U.S. Cl. 228/37

(57) ABSTRACT

A wave soldering apparatus includes: two parallel tracks; a soldering bath defining a wave soldering region between the tracks for soldering circuit boards passing therethrough; a conveying unit including two belts that are movably and respectively mounted on the tracks, and a plurality of clamping members mounted on the belts; and two adjusting mechanisms, each of which is mounted on a respective one of the tracks and each of which includes a pressing plate that is disposed at a top side of the wave soldering region and that is adjustable in height relative to the tracks so as to press downwardly against the clamping members that are under the pressing plate.

### BACKGROUND OF THE INVENTION

1. Field of the Invention

This invention relates to a wave soldering apparatus, more particularly to a wave soldering apparatus including a pressing plate pressing downwardly against clamping members on a conveying belt.

2. Description of the Related Art

FIGS. 1 and 2 illustrate a conventional wave soldering apparatus including two parallel tracks 12, a soldering bath 11 disposed between the tracks 12, two belts (not shown) mounted movably and respectively on the tracks 12, and a plurality of clamping members 13 secured to the belts for clamping carrier trays 101 carrying circuit boards 100 thereon, respectively. In operation, each circuit board 100 carried by the respective carrier tray 101 is advanced in a board-advancing path (L) by the belts to pass through a wave soldering region 110 of the soldering bath 11 so as to permit welding of electronic components 10 to the circuit board 100. However, since the soldering temperature of the solder bath 11 is relatively high, each carrier tray 101 suffers from undesired deformation when passing through the wave soldering region 110, as best illustrated in FIG. 3, thereby resulting in an insufficient welding region 14 on the circuit board 100 (see FIG. 1). Moreover, since movement of the belts tends to deviate slightly from and fluctuate up and down with respect to the board-advancing path (L), as best illustrated in FIG. 4, application of the solder on a desired region 15 on the circuit board 101 is prone to failure.

### SUMMARY OF THE INVENTION

Therefore, an object of the present invention is to provide a wave soldering apparatus that can overcome the aforesaid drawbacks associated with the prior art.

According to this invention, a wave soldering apparatus comprises: two parallel tracks; a soldering bath defining a wave soldering region between the tracks for soldering circuit boards passing therethrough; a conveying unit including two belts that are movably and respectively mounted on the tracks, and a plurality of clamping members mounted on the belts and adapted to clamp two opposite sides of each of perforated carrier trays which carries a respective one of the circuit boards thereon so as to convey each of the circuit boards to pass through the wave soldering region of the soldering bath; and two adjusting mechanisms, each of which is mounted on a respective one of the tracks and each of which includes a pressing plate that is disposed at a top side of the wave soldering region and that is adjustable in height relative to the tracks so as to press downwardly against the clamping members that are under the pressing plate.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic partly sectional view of a conventional wave soldering apparatus;

FIG. 2 is a schematic top view of the conventional wave soldering apparatus;

FIG. 3 is a schematic view illustrating a state where a carrier tray suffers from undesired deformation when passing through a soldering bath of the conventional wave soldering apparatus;

FIG. 4 is a schematic view illustrating another state where the carrier tray deviates from a board-advancing path when passing through the soldering bath of the conventional wave soldering apparatus;

FIG. 5 is a schematic partly sectional view of the preferred embodiment of a wave soldering apparatus according to this invention;

FIG. 6 is a schematic top view of the preferred embodiment; and

FIG. 7 is a schematic cutaway, partly sectional view of the preferred embodiment.

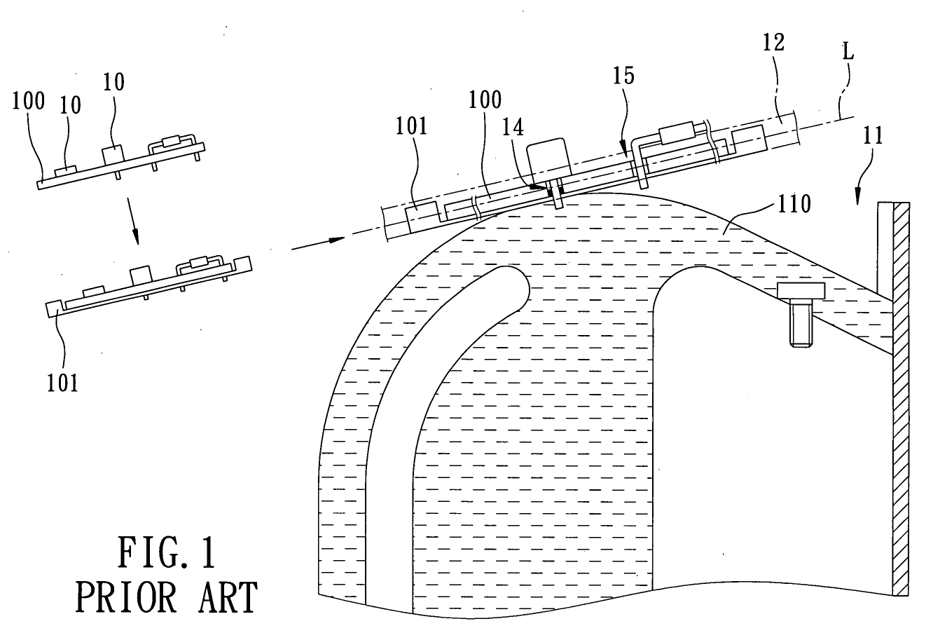

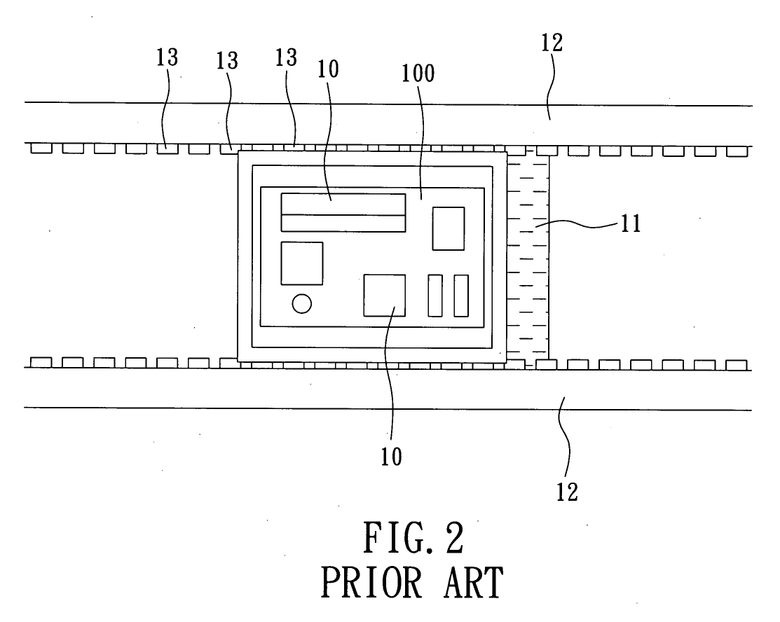

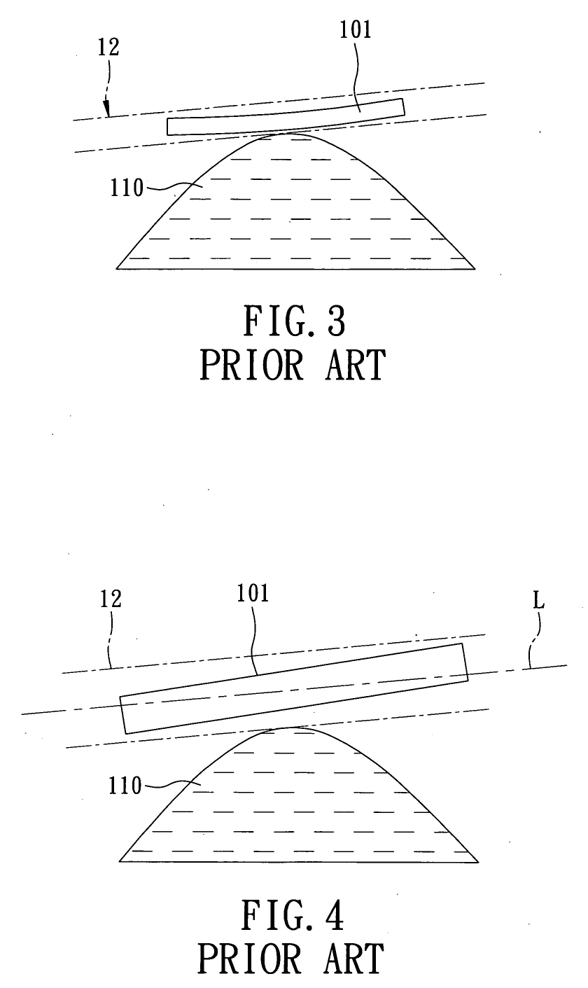

### DETAILED DESCRIPTION OF THE PREFERRED EMBODIMENT

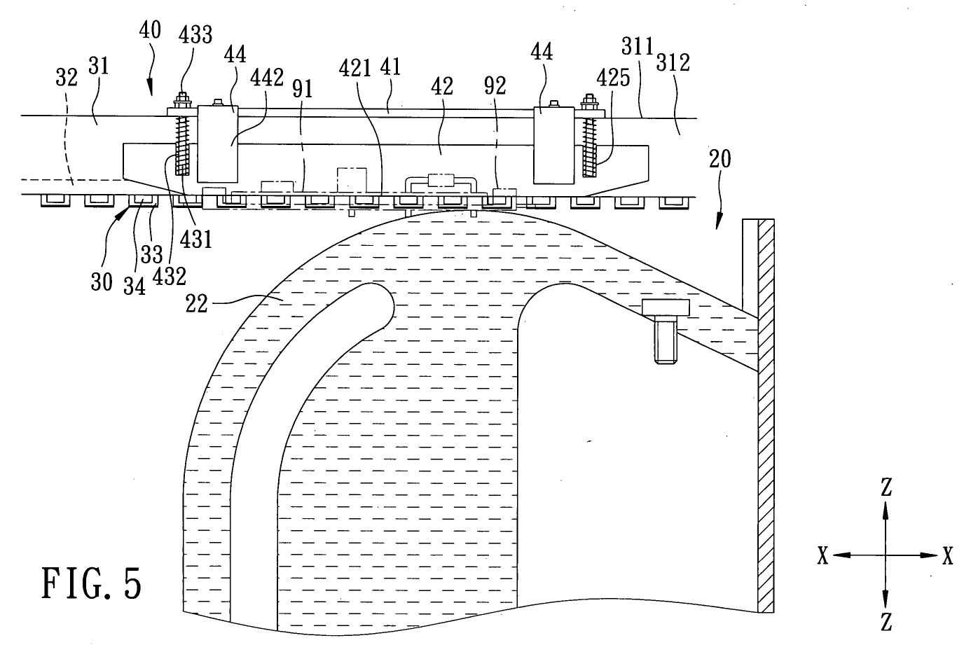

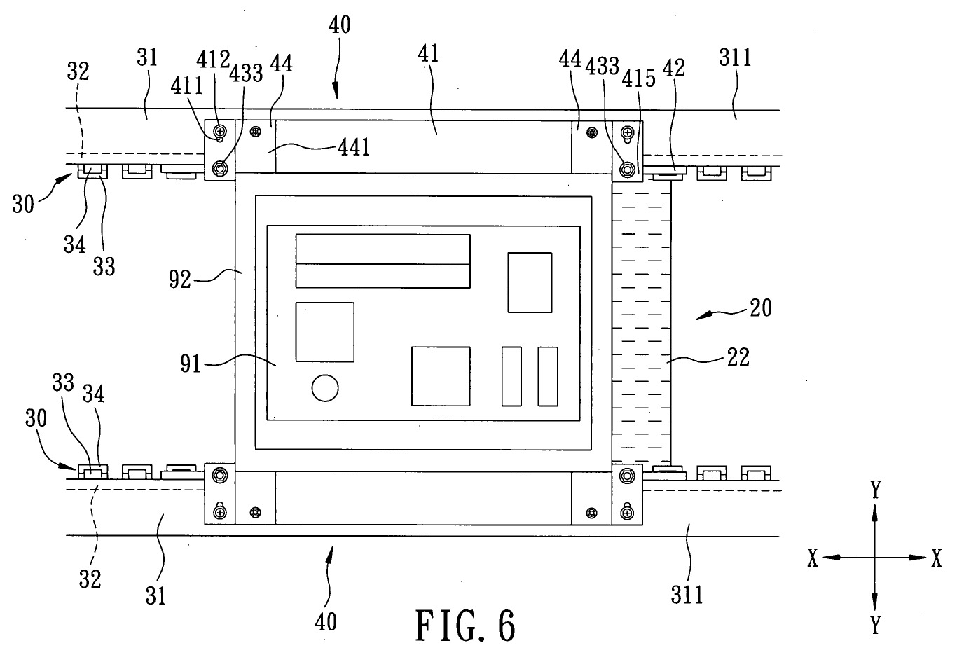

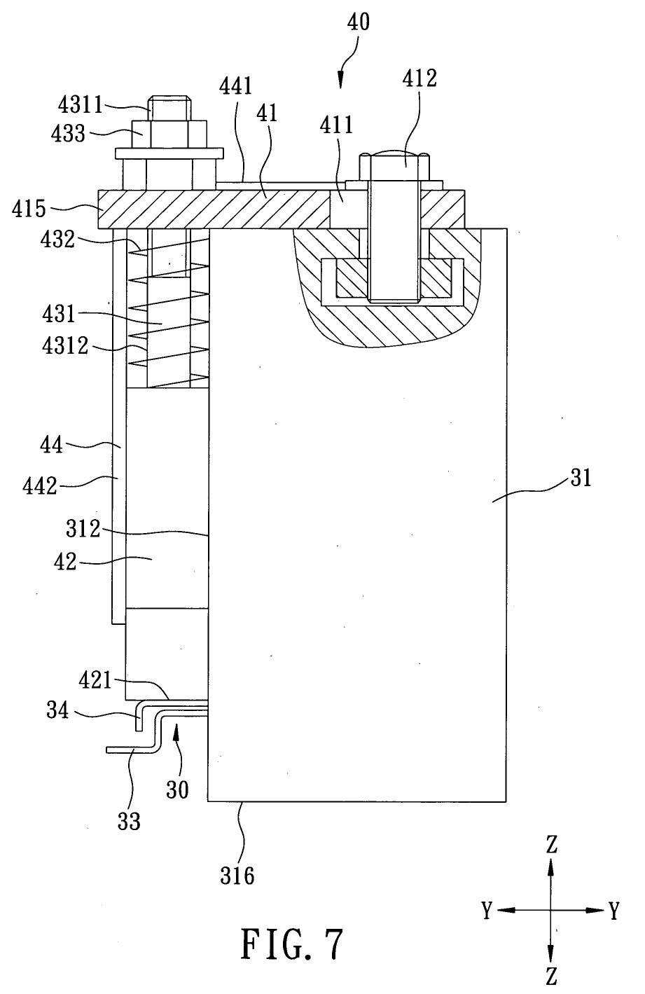

FIGS. 5 to 7 illustrate the preferred embodiment of a wave soldering apparatus according to the present invention. The wave soldering apparatus includes: two parallel tracks 31; a soldering bath 20 defining a wave soldering region 22 between the tracks 31 for soldering circuit boards 91 passing therethrough; a conveying unit including two belts 32 that are movably and respectively mounted on the tracks 31, and a plurality of clamping members 30 mounted on the belts 32 and adapted to clamp two opposite sides of each of perforated carrier trays 92 which carries a respective one of the circuit boards 91 thereon so as to convey each of the circuit boards 91 to pass through the wave soldering region 22 of the soldering bath 20 (see FIG. 5); and two adjusting mechanisms 40, each of which is mounted on a respective one of the tracks 31 and each of which includes a pressing plate 42 that is disposed at a top side of the wave soldering region 22 and that is adjustable in height relative to bottoms 316 of the tracks 31 so as to press downwardly against the clamping members 30, which are moved into the top side of the wave soldering region 22 of the soldering bath 20 (see FIG. 7) under the pressing plate 42, on a respective one of the belts 32. Each of the clamping members 30 includes lower and upper clamping arms 33, 34 for clamping the carrier tray 92.

In this embodiment, the pressing plate 42 of each of the adjusting mechanisms 40 has an elongate planar bottom surface 421 abutting against the clamping members 30 that are under the pressing plate 42.

The tracks 31 extend in a board-advancing direction (X) and are opposite to each other in a transverse direction (Y) relative to the board-advancing direction (X). The pressing plate 42 of each of the adjusting mechanisms 40 extends in a vertical direction (Z) perpendicular to the board-advancing direction (X) and the transverse direction (Y), and is further adjustable in position in the transverse direction (Y).

In this embodiment, each of the tracks 31 has a top end face 311 and an inner side face 312 transverse to the top end face 311. The pressing plate 42 of each of the adjusting mechanisms 40 is disposed adjacent to the inner side face 312 of the respective one of the tracks 31. Each of the adjusting mechanisms 40 further includes a mounting plate 41 that is mounted on the top end face 311 of the respective one of the tracks 31, and that has a free end portion 415 disposed above the wave soldering region 22 of the soldering bath 20 and connected to the pressing plate 42. The mounting plate 41 is formed with a pair of elongate holes 411, each of which extends in the transverse direction (Y). Each of the adjusting mechanisms 40 further includes a pair of fastening members 412, each of which extends through a respective one of the elongate holes 411 in the mounting plate 41 and into a respective one of the tracks 31 and each of which engages threadedly the respective one of the tracks 31 so as to permit fastening of the mounting plate 41 of each of the adjusting mechanisms 40 to the respective one of the tracks 31 and position adjustment of the pressing plate 42 of each of the adjusting mechanisms 40 in the transverse direction (Y).

Each of the adjusting mechanisms 40 further includes a pair of screw rods 431, each of which extends through the free end portion 415 of the mounting plate 41 and each of which has an upper end portion 4311 disposed above the mounting plate 41 and a lower end portion 4312 secured to the pressing plate 42, and a pair of screw nuts 433, each of which engages threadedly the upper end portion 4311 of a respective one of the screw rods 431 so as to permit height adjustment of the pressing plate 42 of each of the adjusting mechanisms 40 relative to the bottoms 316 of the tracks 31.

The pressing plate 42 of each of the adjusting mechanisms 40 is formed with a pair of retaining holes 425. The lower end portion 4312 of each of the screw rods 431 extends into a respective one of the retaining holes 425 in the pressing plate 42. Each of the adjusting mechanisms 40 further includes a pair of compression springs 432, each of which extends into a respective one of the retaining holes 425 in the pressing plate 42, each of which is sleeved around the lower end portion 4312 of a respective one of the screw rods 431, and each of which abuts resiliently against the pressing plate 42 and the free end portion 415 of the mounting plate 41.

Each of the adjusting mechanisms 40 further includes a pair of L-shaped protecting plates 44, each of which has a mounting segment 441 mounted on the mounting plate 41, and a protecting segment 442 transverse to and extending from the mounting segment 441 and disposed adjacent to the pressing plate 42 such that the pressing plate 42 is disposed between the protecting segments 442 of the protecting plates 44 and the inner side face 312 of the respective one of the tracks 31.

With the inclusion of the pressing plate 42 of each of the adjusting mechanisms 40 in the wave soldering apparatus of this invention, the aforesaid drawbacks associated with the prior art can be considerably alleviated.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A wave soldering apparatus comprising:
two parallel tracks;
a soldering bath defining a wave soldering region between said tracks for soldering circuit boards passing therethrough;
a conveying unit including two belts that are movably and respectively mounted on said tracks, and a plurality of clamping members mounted on said belts and adapted to clamp two opposite sides of each of perforated carrier trays which carries a respective one of the circuit boards thereon so as to convey each of the circuit boards to pass through said wave soldering region of said soldering bath; and
two adjusting mechanisms, each of which is mounted on a respective one of said tracks and each of which includes a pressing plate that is disposed at a top side of said wave soldering region and that is adjustable in height relative to said tracks so as to press downwardly against said clamping members that are under said pressing plate.

2. The wave soldering apparatus of claim 1, wherein said pressing plate of each of said adjusting mechanisms has an elongate planar bottom surface abutting against said clamping members that are under said pressing plate.

3. The wave soldering apparatus of claim 1, wherein said tracks extend in a board-advancing direction and are opposite to each other in a transverse direction relative to the board-advancing direction, said pressing plate of each of said adjusting mechanisms being further adjustable in position in the transverse direction.

4. The wave soldering apparatus of claim 3, wherein each of said tracks has a top end face and an inner side face transverse to said top end face, said pressing plate of each of said adjusting mechanisms being disposed adjacent to said inner side face of the respective one of said tracks, each of said adjusting mechanisms further including a mounting plate that is mounted on said top end face of the respective one of said tracks, and that has a free end portion disposed above said wave soldering region of said soldering bath and connected to said pressing plate, said mounting plate being formed with an elongate hole extending in the transverse direction, each of said adjusting mechanisms further including a fastening member extending through said elongate hole in said mounting plate and into a respective one of said tracks and engaging threadedly the respective one of said tracks so as to permit fastening of said mounting plate of each of said adjusting mechanisms to the respective one of said tracks and position adjustment of said pressing plate of each of said adjusting mechanisms in the transverse direction.

5. The wave soldering apparatus of claim 4, wherein each of said adjusting mechanisms further includes a screw rod extending through said free end portion of said mounting plate and having an upper end portion disposed above said mounting plate and a lower end portion secured to said pressing plate, and a screw nut engaging threadedly said upper end portion of said screw rod so as to permit height adjustment of said pressing plate of each of said adjusting mechanisms relative to said tracks.

6. The wave soldering apparatus of claim 5, wherein said pressing plate of each of said adjusting mechanisms is formed with a retaining hole, said lower end portion of said screw rod extending into said retaining hole, each of said adjusting mechanisms further including a compression spring extending into said retaining hole in said pressing plate, sleeved around said lower end portion of said screw rod, and abutting resiliently against said pressing plate and said free end portion of said mounting plate.

7. The wave soldering apparatus of claim 4, wherein each of said adjusting mechanisms further includes an L-shaped protecting plate mounted on said mounting plate, and having a protecting segment disposed adjacent to said pressing plate such that said pressing plate is disposed between said protecting segment of said protecting plate and said inner side face of the respective one of said tracks.
